(19) United States
(12) Patent Application Publication
(10) Pub. No.: US 2014/0100933 A1
(43) Pub. Date: Apr. 10, 2014

(54) METHOD AND SYSTEM FOR OPERATING A DIGITAL SHOPPING NETWORK

(71) Applicant: IMPACT MOBILE INC., Toronto (CA)

(72) Inventor: Gary David SCHWARTZ, Toronto (CA)

(73) Assignee: IMPACT MOBILE INC., Toronto (CA)

(21) Appl. No.: 13/647,668

(22) Filed: Oct. 9, 2012

(30) Foreign Application Priority Data
Oct. 5, 2012 (CA) 2791768

(51) Int. Cl. G06Q 30/02

(52) U.S. Cl. 705/14.26; 705/14.54

(57) ABSTRACT

A Digital Shopping Network allows consumers to interact with a call to action (CTA) displayed with a unique serialized actionable medium. The actionable medium is associated with a uniquely identifiable variable offer at a public site. When the consumer responds to the CTA, a time variable offer response is generated by a processor accessing variable data stored in a Digital Network Database (DND) for that serialized actionable medium. The DND may include an Offer Database for multiple offer responses, including the time variable offer response, each offer response corresponding to a time variable description for a corresponding CTA available to the consumer at the public site. The offer response is communicated to the consumer, or to a designated recipient, via a mobile communication network, the Internet or other electronic means. The invention includes a network system, software program and a method of operating the network.

### FIELD OF THE INVENTION

The invention relates to a method, system and computer program product and service for the dynamic delivery of promotional offers, stored value, and purchase transactions of goods and/or services via mobile devices.

### BACKGROUND

There is a growing trend among young shoppers, busy professionals and affluent consumers to communicate via hand held personal electronic communication devices, including smart phones, small notebook type computers and other mobile electronic communications devices. These individuals are also likely to rely on their communications devices to search for goods and services, businesses offering those goods and services, and any promotional offers relating to those items which may be of interest to them.

Shoppers and potential consumers are becoming more accustomed to using their mobile communication devices for their everyday shopping needs, purchases of durable goods or long term services, and a variety of goods and services that traditionally, were offered in print media, broadcast media, and websites which could be located using internet based search engines or other means.

Potential consumers are often more inclined to complete a purchase or respond to a commercial offer if the consumer is able to obtain prompt or virtually immediate access to more detailed information explaining an advertised offer for a particular product or service. The likelihood of a consumer response to a call to action is also enhanced if the consumer is able to view a display or advertisement offering the product or service of potential interest, while the shopper is able to explore more detailed information relating to that product or service.

Currently, mobile campaigns and commercial offers with short code, QR code, and other mobile calls to action (“CTA”) are prolific in the market and they are familiar to mobile consumers. There is an element of difficulty in managing these known and existing campaigns and offers, for example, because companies are faced with deadlines for print, publication, and deployment to the market to advertise a new promotion or a limited time offer. There may also be problems with consumer confusion if the CTA remains in the marketplace beyond the end of the mobile campaign, or after the term of the commercial offer, or if the CTA requires modification during the in-market period.

Many of the known systems for offering and promoting CTA incorporate various limitations in terms of scope, content, location, duration, or a combination thereof.

Consequently, there is a need for an improved method and system for delivering promotional offers, simplifying the procedures for distributing, changing and/or upgrading those promotional offers, replacing expired offers, and for improved simplicity and flexibility in managing and operating such a system.

### SUMMARY OF THE INVENTION

The invention includes a solution for reducing the complexity of mobile marketing and mobile commerce by allowing an operator or commercial service provider to deploy the CTA a single time into the field, while allowing the promotion connected to the CTA to be changed dynamically through a back end system (such as for example, a computer or network of computers handling the calculation-intensive data of a large enterprise or various businesses). In prior systems, QR codes, NFC tags, or, short codes or key words would be linked to a specific promotion of specific scope and of limited duration which would make such links irrelevant or obsolete in a relatively short time period.

Rather than deploying such fixed link promotions with inherent limitations, the invention allows the marketer/retailer or Digital Shopping Network service provider to deploy a fixed CTA that can stay in the market indefinitely while keeping the mobile campaign and commercial offer relevant and current through a dynamic network-based solution.

The invention further provides the marketer/retailer or service provider with ways to improve customer service and the potential to reduce the costs of offering service. For example, in one embodiment, the invention includes a deployment of a CTA on each seat in a stadium that would allow a user, such as a consumer or potential customer, to scan, text, snap, or tap a CTA, triggering a unique transaction that can be tracked back to that seat. By responding to this CTA, the user can place and complete payment for an order through the user's mobile device, and stadium personnel need only deliver the order to the patron, to complete the transaction. In other embodiments of this example, a stadium would be able to offer special deals on concessions to large groups of related patrons because the stadium concessions would know where the patrons will be sitting, for a specific game/event, and the system of the invention could be managed to have all orders from their designated seats discounted by 15%, for example, or other special offers could be designed and addressed to specific groups within that stadium. The system may also be adapted to extend the special offer to a specific large group sitting in those seats during the afternoon baseball game, but the offer will expire so that it is no longer available to those patrons who will be sitting in those seats for a following evening concert.

In another aspect of this invention, a media display may be combined with a CTA to allow retailers to extend their product availability to non-traditional locations. For example, a simple back-lit display may be set up in a remote location, such as a movie theatre, to promote books sold elsewhere, or in a display located in a mall to sell shoes which may be available in the mall or elsewhere. In some aspects, the media display may be divided into a number of frames so that each frame is associated with a short code, image, QR code, and/or NFC tag (i.e. each corresponding to the frame's display area). While the product information may be changed by inserting a new transparency with the new items (books or shoes), the CTA including the NFC tag does not need to be changed as the campaign information corresponding to the frame is managed in the back end system.

Another aspect of the invention includes a method and system for digital gifting. Prepaid gift cards historically have been sold in retail locations as plastic cards. Traditionally, the gift cards are activated when purchased and it is necessary to physically deliver the activated gift card to the intended recipient.

In another aspect of the invention, currency, loyalty points, and other rewards may be assigned or awarded to digital PINs and unique identification numbers associated with hand held personal communication devices. Values in amounts of currency, loyalty points, and/or other rewards may be transferred to potential recipients. In promotional or commercial offers associated with the use of digital PINs, the invention may be used with multiple stored value “cards” such as XBOX Live™ and iTunes™, to allow such cards and the like to be purchased and gifted electronically via the shopper mobile device, while the system is managed remotely. The method and system of the invention may be adapted to allow a purchaser of the gift card to request that the electronic gift card be delivered to the personal communication device of the gift recipient, where the recipient's cell phone number or other unique identification information (for example, other unique information associated with the recipient's personal communication device) is known.

The present invention provides the ability to dynamically deliver promotional offers and stored value (e.g. coupons, loyalty points, account top-ups, and the like), and enable associated purchase transactions via mobile devices, and allows the consumer to “opt-in” for ongoing communication from the offer provider. Consumers may be exposed to a call to action at a fixed location such as a service or retail location, building, poster, billboard, bus shelter, or other structures, conveyances, or stationary devices. The call to action contains one or many options of actionable media for the consumer to interact with, e.g. texting a keyword to a short code, scanning a 2D code (QR Code), taking a picture (using photo recognition software), or “tapping” an NFC chip. Each actionable medium is serialized with a unique identification to identify the specific location of interaction. Interaction by the consumer with the actionable medium generates a response to the consumer's mobile device (smart phone, tablet, etc.) such as receiving a message (eg. SMS, MMS, email, and/or, other push notification via an application), or opening a browser or third party application, resulting in the ability to create a “date and time stamp” of interaction. The combination of location, date, and time are used to reference a dynamic “offer database” which contains the unique response to be provided to the consumer's mobile device (or another designated device, if requested). For clarification, the “offer table” is maintained in a network element that may, for example, apply logic to provide a different response to the user depending on the time of day or date, for example, that the user initiates the interaction. Further aspects of the invention may include options to allow interaction with third party applications and/or databases, such as customer relationship management (CRM) systems, so that user profiles may also be factored into the offer to be provided to potential customers.

The consumer may use his or her suitably adapted mobile device to interact with the Digital Shopping Network and other integrated applications or databases storing further information about the mobile user (eg. a CRM system) or about the area surrounding the location of the CTA (eg. a local events calendar) to enable the Digital Shopping Network to provide offers to the mobile user that are more suitably tailored to the mobile user's unique interests or preferences. The consumer may also be provided with opportunities to participate in offers relating to participating businesses at various locations, some of which may be remotely situated away from the CTA and the associated actionable medium.

In some aspects, an offer may give the mobile user (customer) the option to complete a purchase transaction immediately, or at a later date, using the customer's mobile device.

A customer may be able to complete a purchase transaction specifically linked to the location of the actionable media or the time and/or date of the consumer interaction with the actionable media (or actionable medium, as the case may be). For example, the user may access a list of time variable offers within a selected range of future dates and times or events associated with the site location of the selected actionable medium. The consumer may select one or more of the available offers posted for a range of particular dates and times and any special events, and the customer may apply those offers to the future purchase of goods and/or services when those offers become available. For example, the Digital Shopping Network may provide the customer with an opportunity to prearrange purchases in advance of the date and time of a particular event (for example, a concert or sports game) or in advance of a major promotional campaign offering discounted sales prices to customers, including programs which may have limited quantities of available goods or services packages.

Other aspects of the invention will become apparent upon a review of the appended drawings and the following detailed description of preferred embodiments of the invention.

### DESCRIPTION OF THE DRAWINGS

FIG. 1 is a table showing a summary of information stored in an example of an offer, associated with a CTA, summarized in an Offer Database in a preferred embodiment of the invention;

FIG. 1A is a schematic representation of an embodiment of a Digital Shopping Network accessible to a customer at one or more locations;

FIG. 2 is a front view of an example of a personal mobile communication device, namely a smart phone, which may be used to interact with the preferred embodiment of the invention;

FIG. 3 illustrates some examples of actionable media which may be included in the method and system of the invention, including the preferred embodiment;

FIG. 4 is a drawing of an example of a serialized ID tag associated with the preferred embodiment;

FIG. 5 is a table of summarized information stored in an Inventory Database associated with the preferred embodiment;

FIG. 6 is a schematic representation of an example of the steps in accessing and operating a Network Software program included in the preferred embodiment of the invention;

FIG. 7 is a table of summarized information stored in a Media Database associated with the preferred embodiment; and

FIG. 8 is a schematic representation of a preferred method and system of the invention in which the personal communication device (namely, the smart phone) of FIG. 2 is used to scan an actionable medium illustrated in FIG. 3, to access and interact with the method, system and software of the preferred embodiment as illustrated in FIG. 6.

### DETAILED DESCRIPTION OF THE INVENTION

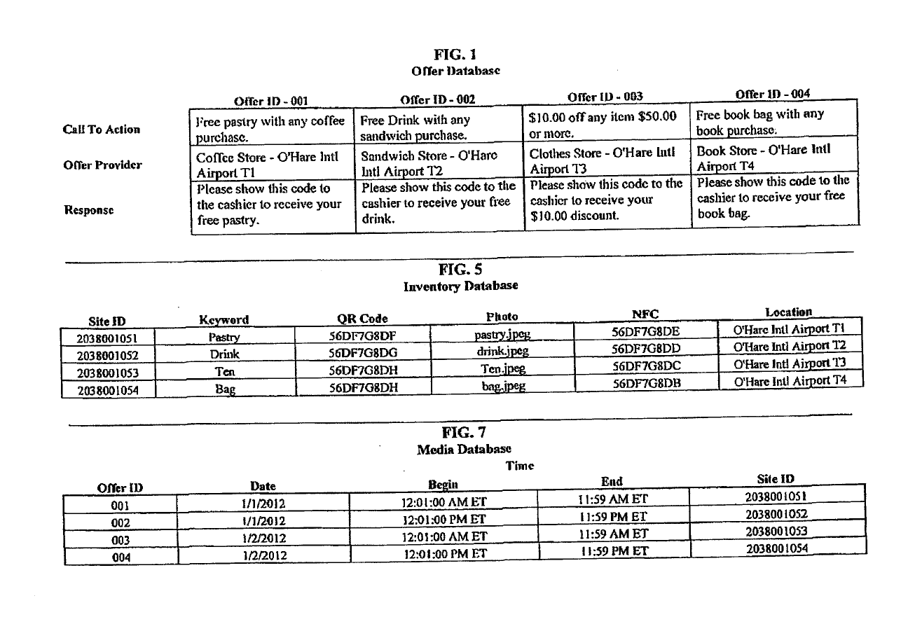

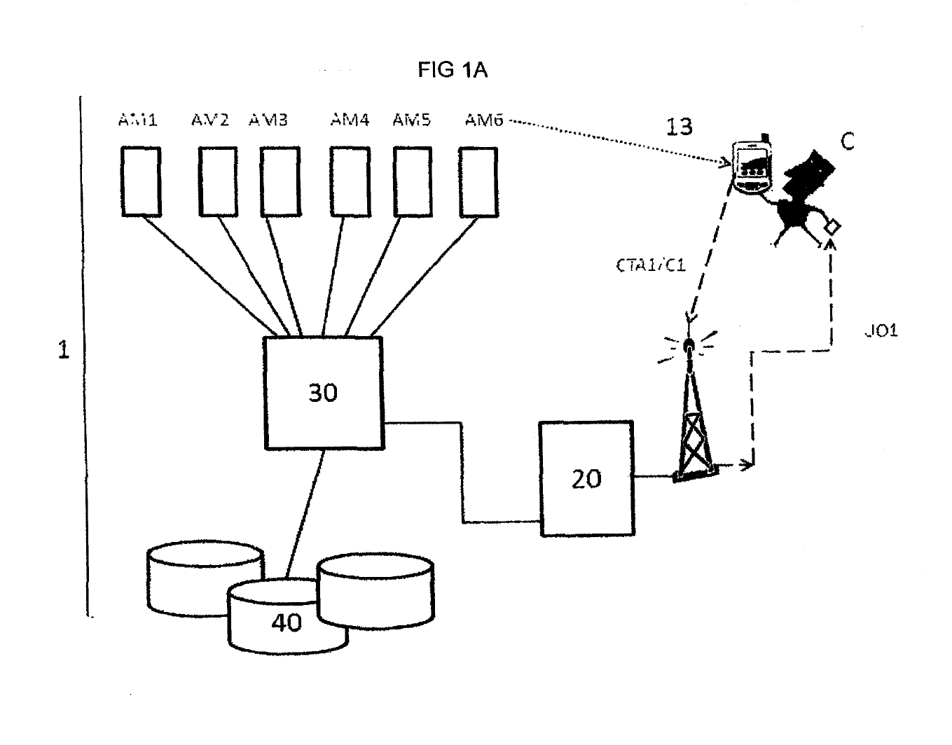

The invention includes a Digital Shopping Network, a method of operating the Network, and a software program for the management and operation of the Network. In FIG. 1A, a simplified example of a Digital Shopping Network 1 is illustrated. A consumer C with a smart phone 13 comes into contact with, or becomes aware of, a call to action (CTA) depicted on a display (for example, a billboard or electronic screen) corresponding to an actionable medium AM1. For example, if AM1 incorporates an NFC tag, consumer C may tap the NFC tag of AM1, to communicate with the Digital Shopping Network 1, via a mobile service provider 20, to access further information concerning an available offer associated with AM1 at the time of the consumer's inquiry C1. The consumer's inquiry communication C1 is received by a processor 30 which in turn accesses relevant information from a Digital Network Database (DND) 40. The processor 30 matches the consumer's inquiry C1, including information identifying AM1 and corresponding data stored within the DND 40 concerning CTA1 associated with the AM1 at the time of the consumer's inquiry C1. The consumer's inquiry C1 may be date and time stamped, and provided with a unique serialized identification number.

The database, DND 40, may include:
(i) an Offer Database comprising descriptions of the various calls to action (CTAs) wherein one CTA is associated with one of the actionable media AM1, AM2, AM3, AM4, AM5, AM6 within the Network 1. As shown in FIG. 1A, CTA1 is associated with AM1. The Offer Database also includes a unique offer response stored for each CTA, for example, unique offer UO1 corresponding to CTA1 depicted or posted at AM1 at the time of the consumer inquiry. For example, UO1 may be available for a limited period of time on one day, in connection with a special event at a specified location;
(ii) an Inventory Database comprising data describing a plurality of uniquely identifiable offers available to the consumer C at the location. For example, actionable media AM1 to AM6 may all be accessible to the consumer C at one site, near a stadium. The Inventory Database preferably includes detailed information relating to each of the uniquely identifiable offers, such that each offer is associated with a corresponding actionable medium within the set of actionable media AM1 to AM6; and
(iii) a Media Database comprising data identifying the various uniquely identifiable offers, including the unique offer associated with CTA1 at the time of the consumer's inquiry C1, the time availability of that offer, and the site location associated with AM1.

In the illustrated example in FIG. 1A, consumer C1 receives an unique offer U01 in response to his inquiry C1 concerning CTA1 associated with actionable medium AM1 (for example at a stadium). The consumer may choose to apply the unique offer U01 to a purchase of a product or service associated with CTA1. (In other examples, the consumer may choose to accept customer rewards, purchase a gift, or complete another transaction to which another uniquely available offer may be applied.)

The processor 30 may also be used to update and modify the data stored in DND 40 associated with each of the actionable media AM1 to AM6. A system operator may access the network database DND1 via the processor 30 to introduce updated information associated with each corresponding unique offer, to incorporate new or replacement offers, to modify the calls to action, and in some embodiments, to update the related advertising associated with each actionable medium when offers or promotional programs, expire or are modified to incorporate corrections, new descriptions, or additional information. In some instances, although the actionable media is intended for repeated re-use, occasionally the actionable medium may be replaced or modified when it is desirable or necessary to do so.

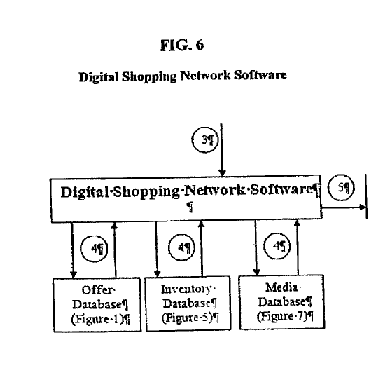

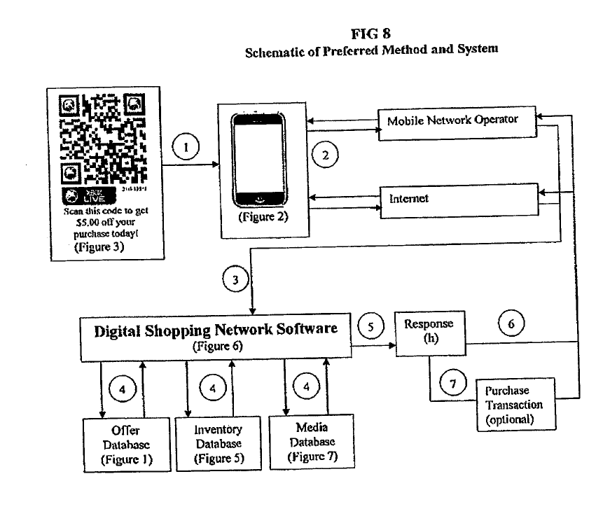

FIG. 1, FIG. 5 and FIG. 7 illustrate a preferred embodiment of a simplified Digital Network Database (DND). The illustrated example of the DND comprises three inter-related component databases, an Offer Database shown in FIG. 1, an Inventory Database in FIG. 5, and a Media Database illustrated in FIG. 7. In FIG. 1, the simplified example of an Offer Database lists four unique time limited offers, each having its own serialized ID, and each serialized offer ID is identified along with its corresponding call to action (CTA), the identity of the offering merchant/business and the predetermined Response to be provided to a consumer in response to the consumer inquiry triggered by interaction with a corresponding actionable medium. In FIG. 5, an Inventory Database lists the unique site IDs for each of four actionable media displayed at one location (an actionable keyword, QR Code, photo (for use with photo recognition software), and an NFC tag). In this example, each time variable CTA and associated Offer ID is provided with four unique actionable media in which each unique actionable medium is in a format which is distinguishable from the formats of the other three actionable media (for example, one actionable keyword, one unique QR Code, one unique photo image, and one unique NFC tag). In FIG. 7, an example of a Media Database identifies the dates, start times and finish times for each unique Offer ID assigned to a particular site ID. Persons skilled in the art will realize that these examples have been simplified for convenience and ease of understanding. It will be appreciated that most of the data entered in the database may be updated, modified and replaced when necessary, or when it is desirable to do so. Typically, expired Offers will no longer be accessible or available to customers accessing the Digital Shopping Network. Current and future Offers will be made available, and/or entered into the Digital Network Database on an ongoing basis to replace expired Offers, with currently available Offers being assigned to their designated actionable media at their corresponding locations. The data may be entered into these databases at a location which is remote from the location of the uniquely serialized actionable media displayed in various publicly accessible locations. In some embodiments, particularly where electronic displays, monitors and the like are used to display promotions, the serialized actionable media may also be modified, updated or replaced, from a remote location, in those instances when it is desirable or necessary to do so. Similarly the databases may be remote from the processor, or from an access point, such as a terminal (or multiple terminals) which may be used to enter new data into the DND, either to replace expired Offers, modify or replace existing offers, and to enter future offers to be assigned to their corresponding, uniquely serialized actionable media.

FIG. 4 illustrates an example of a serialized ID in a scannable format. Serialization or assigning a serialized ID to a site location, a specific CTA, or other component within the Digital Shopping Network may be accomplished by displaying a serialized ID tag or another unique identifier in another format, including, but not limited to, smart chips, NFC interactive components and other suitable identifiers. By way of example, the serialized ID may be embodied in an alphanumeric code, tag, label, chip, symbol, image, transmitting device, or other display element posted or applied, near, on, or in a physical structure or other feature associated with an advertising, promotional or marketing display including a CTA. Preferably, the serialized ID is securely displayed in a protected environment to inhibit damage, vandalism, or tampering which might interfere with the ongoing re-use and operation of the serialized ID in association with other time variable elements, including CTAs which may be updated and modified from time to time, within the Network. The serialized ID may also be suitable for modification, repair or replacement from time to time. In some embodiments, it will be possible to modify, repair or replace one or more serialized IDs deployed in a Network from locations which are remote from the serialized IDs, the associated CTAs, publicly displayed actionable media, and the like. Other embodiments will also be apparent to persons skilled in the art who will understand that this description merely provides illustrative examples.

In FIG. 1A, Consumer C may also choose to respond to other CTAs associated with a plurality of corresponding actionable media AM2, AM3, AM4, AM5, AM6, within the Digital Shopping Network 1.

Typically, the customer's smart phone 13 is uniquely identifiable with a personal identification number reserved for that device or an email address account accessible through that device, or a unique phone number associated with that device. The customer's inquiries, purchases and other interactions with the Digital Shopping Network may be used to compile information relating to that customer's interests, preferences, and buying behaviors. That unique customer information may be forwarded to other databases and networks used to track such behaviors, record loyalty rewards, manage customer management accounts, and the like.

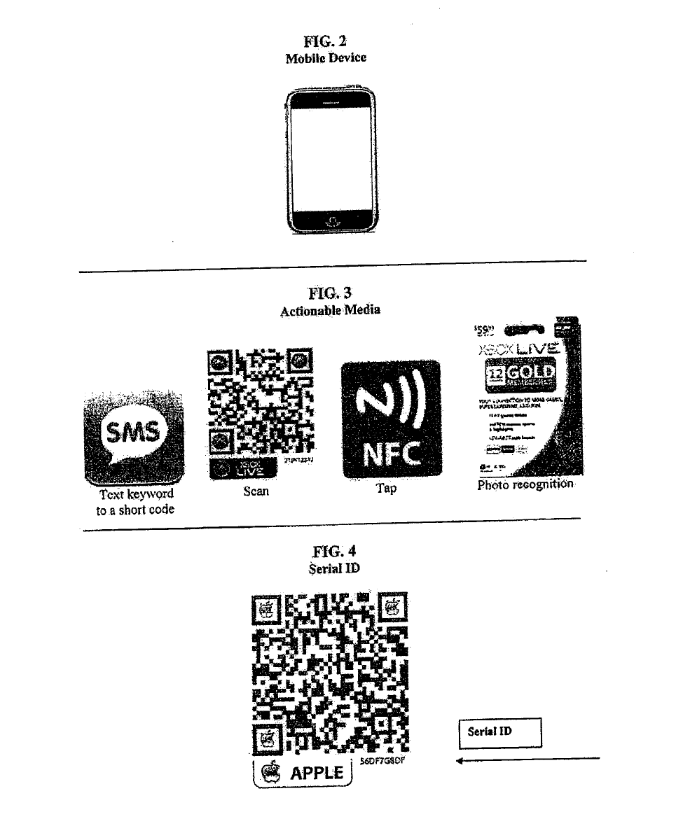

FIG. 8 illustrates a schematic representation of a preferred embodiment of another Digital Shopping Network system and an associated method of operating the network system. An actionable medium, such as a scannable code (an example of which is also shown in FIG. 3) is associated with a call to action, “Scan this code to get $5.00 off your purchase today!” at the time of the consumer interaction. The consumer uses a smart phone (an example of which is also shown in FIG. 2) to scan the scannable code and to communicate with the Digital Shopping Network via either a Mobile Network Operator or via the Internet. For example, a smart phone application may be used to provide additional prompts or instructions to allow the customer to assist in communicating a customer inquiry (or subsequently complete a purchase associated with the offer). The customer inquiry is communicated to the Digital Shopping Network to interact with and access stored information by using the Digital Shopping Network Software (shown in further detail in FIG. 6). The customer's inquiry in response to the call to action, activates the system software to retrieve and communicate a Response h to the consumer's smart phone, either through the Internet, or via the Network Mobile Operator, either depending on how the consumer originally communicated his inquiry, or as requested by the customer, or as determined by an application. The customer may also be provided with an opportunity to complete a purchase transaction, or place a conditional reservation or booking for a future event, and apply the offer response to that future event, when the customer elects to complete the purchase or other transaction at a later date.

The method for accessing the Digital Shopping Network may also be summarized, having regard to FIG. 8, as follows.
1. A consumer responds to a call to action using serialized actionable media.
2. The type of actionable media that the consumer interacts with, and the type of consumer experience associated with the offer represented by the actionable media, will determine if the mobile device interacts first with an application, the Internet or a Mobile Network Operator.
3. The customer inquiry notification is sent via the Internet or Mobile Network Operator to the Digital Shopping Network Software after the consumer has interacted with a serialized actionable medium. This customer inquiry notification may start within an application on the mobile device that triggers such an interaction.
4. The Digital Shopping Network Software queries and retrieves data from the Offer Database, Inventory Database, and the Media Database in response to the customer notification inquiry.
5. Business logic contained in the Digital Shopping Network Software is used to determine an appropriate offer response h to the consumer's interaction with the serialized actionable medium.
6. Depending on the type of offer response generated from the Digital Shopping Network Software, the offer response communication is routed through the Internet or Mobile Network Operator back to the consumer's mobile device (possibly via an application on the device).
7. Optionally, the Digital Shopping Network may include an offer response which allows the consumer to complete a purchase transaction.

In another embodiment, a method for operating the Digital Shopping Network comprises the steps of:
(a) dynamically delivering to a consumer via a “mobile device” [FIG. 2] a promotional offer and/or a stored value, or access points to a third party application or database which contains components that may include promotional offers and/or stored value, all or some of which may be stored in a “offer database” [FIG. 1];
(b) receiving a customer inquiry notification in response to a call to action inviting the consumer to interact with one or more “actionable media” [FIG. 3] which is capable of being messaged, photographed, scanned, or tapped by a suitably enabled mobile device and providing a time and date stamp of the interaction;
(c) the actionable media being “serialized” [FIG. 4] to correspond to a unique location which is stored in an “inventory database” [FIG. 5] and optionally, one or both of the actionable media and the serialized ID tag for the actionable media are modifiable from a remote location;
(d) assembling the collected information to provide the data needed by the Digital Shopping Network Software [FIG. 6], which may or may not be cloud based;
(e) to perform an “offer look-up” against a “media database” [FIG. 7] which contains an Offer ID, Date, Time and Site ID;
(f) to return the appropriate offer response to the consumer's mobile device using an appropriate format including but not limited to: SMS, MMS, URLs, downloads, open an installed application, push notifications, or using other available communication formats.

The numbering of the foregoing steps does not imply or require that the steps must be performed in a certain order, or that the steps must be performed as separate steps. Other methods will be apparent to those skilled in the art in which similar steps may be performed in alternative order, or with more, or fewer steps, to achieve a similar result.

Upon reading the specification, persons skilled in the art will also understand how to design and implement suitable software to carry out the methods of use and operation of the Digital Shopping Network of the present invention.

Persons skilled in the art will appreciate that the foregoing descriptions were directed to specific embodiments of the invention. However, many other variations and modifications of the invention are also possible. Several preferred embodiments of the invention have been described with regard to the appended drawings. It will be apparent to those skilled in the art that additional embodiments are possible and that such embodiments will also fall within the scope of the appended claims.

We claim:

1. A method of providing a Digital Shopping Network, comprising:
providing a consumer with access to a call to action (CTA) displayed with a serialized actionable medium associated with a uniquely identifiable variable offer at a publicly accessible site location;
generating an offer response, upon receiving an inquiry by the consumer concerning the CTA, to retrieve data associated with the serialized actionable medium from a Digital Network Database (DND); and
sending the offer response to the consumer or a designated recipient, the offer response being formulated from the data retrieved from the DND, the response comprising variable programmable information describing the uniquely identifiable variable offer available to the consumer at the time of the inquiry concerning the CTA by the consumer.

2. The method of claim 1, wherein the DND comprises at least one of the following:
an Offer Database comprising the offer response and a time variable description of the CTA available to the consumer at the site location,
an Inventory Database comprising data describing a plurality of uniquely identifiable variable offers available to the consumer at the site location, and
a Media Database identifying: the uniquely identifiable variable offer and the time availability of the uniquely identifiable variable offer at the site location.

3. The method of claim 1, wherein the DND comprises:
an Offer Database comprising the offer response associated with the CTA at the site location;
an Inventory Database comprising data describing a plurality of uniquely identifiable variable offers available at the site location, comprising the uniquely identifiable variable offer; and
a Media Database comprising data identifying: the uniquely identifiable variable offer, the time availability of the uniquely identifiable variable offer, and the site location.

4. The method of claim 1, wherein the serialized actionable medium is selected from the group of serialized actionable media consisting of: a unique short code or keyword; a scannable image; an NFC tag; and a unique image identifiable by photo recognition.

5. The method of claim 1, wherein the consumer communicates the inquiry to the Digital Shopping Network by a personal mobile communication device, a computer terminal, or a telephonic device connected to a land line.

6. In the method of claim 1, the uniquely identifiable variable offer comprising a consumer reward.

7. In the method of claim 6, the consumer reward being selected from a group of rewards consisting of: a product; a service; a discount applicable to a consumer transaction for a product or service; a consumer loyalty reward; and a gift for a designated recipient.

8. In the method of claim 6, wherein the consumer reward is identified with a unique identification alphanumeric sequence associated with the serialized actionable medium.

9. In the method of claim 1, the uniquely identifiable variable offer is limited to the site location and to a time duration specified in the DND.

10. In the method of claim 1, the offer response comprising instructions to complete a consumer purchase transaction via the Digital Shopping Network.

11. In the method of claim 1, the offer response is tagged with a unique personal identification associated with the consumer selected from a group of unique personal identifications consisting of: a unique personal identification number; an account number assigned to the consumer by the Digital Shopping Network; a consumer loyalty account number; a mobile telephone number associated with the consumer; or a unique personal identification number associated with a personal mobile communication device, a computer terminal, or a telephonic device connected to a land line.

12. The method of claim 11 wherein the unique personal identification is encoded in a coupon or gift card identifying the designated recipient.

13. In the method of claim 1, wherein the serialized actionable medium is affixed to a site location defined by a group consisting of:
a building or other immovable structure; a vehicle; a movable electronic display monitor; and a mobile sign.

14. In the method of claim 1, the serialized actionable medium is replaceable with a substitute serialized actionable medium upon an operation entered at a remote location.

15. In the method of claim 1, wherein the consumer is provided with access to a plurality of calls to action, in which each CTA is displayed with a unique serialized actionable medium, each serialized actionable medium being associated with a uniquely identifiable variable offer at the publicly accessible site location.

16. The method of claim 1 comprising the step of modifying an element of the CTA from a remote location, or modifying a description of the uniquely identifiable variable offer from a remote location.

17. In the method of claim 1, the DND comprises a time variable data element selected from the group consisting of:
the CTA;
a description of the unique time variable offer;
a date and time range for the CTA or the description of the unique time variable offer;
the offer response; and
information identifying an entity associated with the CTA.

18. In the method of claim 1, modifying publicly viewable information associated with the CTA at the publicly accessible site location from a remote location.

19. In the method of claim 1, the serialized actionable medium is modifiable from a remote location.

20. In the method of claim 1, the serialized actionable medium comprises a uniquely serialized ID assigned to the publicly accessible site location.

21. In the method of claim 1, the serialized actionable medium comprises a uniquely serialized ID assigned to the publicly accessible site location and a separate actionable medium component, the separate actionable medium being modifiable independently of the uniquely serialized ID.

22. A Digital Shopping Network comprising:
a processor for receiving a consumer inquiry in response to a call to action (CTA) displayed with a serialized actionable medium associated with a uniquely identifiable variable offer at a publicly accessible site location; and
a Digital Network Database (DND), for storing data associated with the serialized actionable medium, comprising variable programmable information describing the uniquely identifiable variable offer available to the consumer at a time assigned to the consumer inquiry concerning the CTA;
wherein the processor generates an offer response to the consumer or a designated recipient, the offer response being formulated from the data retrieved from the DND.

23. The Digital Shopping Network claimed in claim 22 comprising a communication element for communicating the offer response to the consumer or the designated recipient via: a Mobile Communication Network, the Internet, or a land line based network for telephonic communications.

24. The Digital Shopping Network claimed in claim 22, wherein the DND comprises at least one of the following:
an Offer Database comprising the offer response associated with the CTA at the site location;
an Inventory Database comprising data describing a plurality of uniquely identifiable variable offers available at the site location, comprising the uniquely identifiable variable offer; and
a Media Database comprising data identifying: the uniquely identifiable variable offer, the time availability of the uniquely identifiable variable offer, and the site location.

25. The Digital Shopping Network claimed in claim 22, wherein the serialized actionable medium is affixed to a site location defined by a group consisting of: a building or other immovable structure; a vehicle; a movable electronic display monitor; and a mobile sign.

26. The Digital Shopping Network claimed in claim 22, wherein
the serialized actionable medium is replaceable with a substitute serialized actionable medium upon an operation entered at a remote location;
the CTA can be modified from a remote location, or
a description of the uniquely identifiable variable offer can be modified from a remote location,
by modifying the data stored within the DND.

27. In the Digital Shopping Network claimed in claim 22, the DND comprises a time variable data element selected from the group consisting of:
the CTA;
a description of the unique time variable offer;
a date and time range for the CTA or the description of the unique time variable offer;
the offer response; and
information identifying an entity associated with the CTA.

28. In the Digital Shopping Network claimed in claim 22, publicly viewable information at the publicly accessible site location associated with the CTA is modifiable from a remote location.

29. In the Digital Shopping Network claimed in claim 22, the serialized actionable medium is modifiable from a remote location.

30. A Digital Shopping Network for operation according to the method of claim 1.

31. A software program for operation of the Digital Shopping Network in accordance with the method of claim 1.

32. A software program to operate the Digital Shopping Network claimed in claim 22.
